(19) United States
(12) Patent Application Publication
(10) Pub. No.: US 2025/0265745 A1
(43) Pub. Date: Aug. 21, 2025

(54) SYSTEMS AND METHODS FOR CREATING A REALISTIC SCENE INCLUDING A GENERATIVE DRAWING USING LEARNING MODELS

(71) Applicant: Toyota Research Institute, Inc., Los Altos, CA (US)

(72) Inventors: Chuan-En Lin, Pittsburgh, PA (US); Hyeonsu B. Kang, Pittsburgh, PA (US); Nikolas A. Martelaro, Pittsburgh, PA (US); Aniket D. Kittur, Pittsburgh, PA (US); Yin-Ying Chen, San Jose, CA (US); Matthew K. Hong, Mountain View, CA (US)

(73) Assignees: Toyota Research Institute, Inc., Los Altos, CA (US); Toyota Jidosha Kabushiki Kaisha, Toyota-shi Aichi-ken (JP); Carnegie Mellon University, Pittsburgh, PA (US)

(21) Appl. No.: 18/640,882

(22) Filed: Apr. 19, 2024

Related U.S. Application Data
(60) Provisional application No. 63/556,088, filed on Feb. 21, 2024.

(51) Int. Cl. G06T 11/20; G06T 7/13; G06T 7/50; G06T 11/60; G06T 15/50; G06T 15/60

(52) U.S. Cl. CPC G06T 11/203; G06T 7/13; G06T 7/50; G06T 11/60; G06T 15/506; G06T 15/60

(57) ABSTRACT

Systems, methods, and other embodiments described herein relate to creating a realistic scene including a generative drawing using a learning model and image manipulation. In one embodiment, a method includes generating a drawing from a drawn line and text by a machine learning (ML) model. The model also includes predicting a realistic prompt and a scaling amount about the drawing using a language model and estimating a depth map of the drawing using a depth model according to the scaling amount. The model also includes rendering the drawing within a realistic scene by an outpainting model using the realistic prompt and the depth map.

### CROSS-REFERENCE TO RELATED APPLICATIONS

This application claims the benefit of U.S. Provisional Application No. 63/556,088, filed on Feb. 21, 2024, which is herein incorporated by reference in its entirety.

### TECHNICAL FIELD

The subject matter described herein relates, in general, creating a realistic scene including a generative drawing, and, more particularly, to creating the realistic scene using a learning model and the generative drawing that is manipulated.

### BACKGROUND

Tools for designing creative objects and products run graphics engines that reduce development cycles through automating tasks. For instance, designers have a graphics engine morph a sketch according to parameters from stakeholders (e.g., customers). Despite the automation, designers still have many manual tasks during ideation for outputting diverse concepts, such as theme creation. The manual tasks increase design times and frustrate designers particularly with complex products (e.g., vehicles) that involve numerous components.

In various implementations, a text-to-image (T2I) model synthesizes drawings guided by text within certain design platforms. In one approach, the T2I model generates a bumper having a form and style for a particular vehicle. Still, design diversity with the T2I model can be limited when domains that the model searches have a discrete scope. Furthermore, generative drawings using text can lack details and features from modal limits of verbalizing design parameters for a scene. As such, a designer has to manually manipulate outputs from the T2I model for replicating a scene that meets design parameters like implementations leveraging a graphics engine. Outputs changed manually can also demand other models for performing additional iterations with the T2I model. Therefore, systems designing objects using models guided with text can encounter technical difficulties that inhibit creativity and reduce efficiency gains from a T2I model, thereby frustrating users.

### SUMMARY

In one embodiment, example systems and methods relate to creating a realistic scene including a generative drawing using a learning model and image manipulation. In various implementations, tools reducing design times for concepts with learning models encounter constraints that inhibit efficiency. For instance, systems running a text-to-image (T2I) model rapidly design a product from converting visuals using design ideas. Designers are increasingly incorporating T2I models to augment and assist with creative tasks. Nevertheless, a T2I model has limits and can lack features for accurately rendering realistic scenes having generative pictures and following design specifications. As such, designers may not rely upon the T2I model to fully complete a project and perform unnecessary revisions despite the T2I model otherwise having powerful attributes. Therefore, tools integrating a T2I model can be limited with fully completing projects according to design specifications.

Therefore, in one embodiment, an illustration system inspires unique designs from various domains (e.g., nature, fashion, etc.) and renders realistic scenes having the unique designs through iterative sketching and learning models that are guided by sketches and text. In particular, the illustration system generates a drawing using a drawn line and text that are processed by a learning model and renders the drawing within a realistic scene using a generative prompt. In one approach, the illustration system places a generative drawing in realistic settings through predicting a realistic prompt and a scaling amount about the generative drawing using a language model. Furthermore, a depth model estimates a depth map of the generative drawing according to the scaling amount that improves realism. Accordingly, the illustration system produces design ideas from diverse domains related to a subject using text and sketch inputs and renders the design ideas within realistic settings, thereby fully completing design cycles and reducing design times.

In one embodiment, an illustration system for creating a realistic scene including a generative drawing using a learning model and image manipulation is disclosed. The illustration system includes memory storing instructions that, when executed by a processor, cause the processor to generate a drawing from a drawn line and text by a machine learning (ML) model. The instructions also include instructions to predict a realistic prompt and a scaling amount about the drawing using a language model and estimate a depth map of the drawing using a depth model according to the scaling amount. The instructions also include instructions to render the drawing within a realistic scene by an outpainting model using the realistic prompt and the depth map.

In one embodiment, a non-transitory computer-readable medium for creating a realistic scene including a generative drawing using a learning model and image manipulation and including instructions that when executed by a processor cause the processor to perform one or more functions is disclosed. The instructions include instructions to generate a drawing from a drawn line and text by a machine learning (ML) model. The instructions also include instructions to predict a realistic prompt and a scaling amount about the drawing using a language model and estimate a depth map of the drawing using a depth model according to the scaling amount. The instructions also include instructions to render the drawing within a realistic scene by an outpainting model using the realistic prompt and the depth map.

In one embodiment, a method for creating a realistic scene including a generative drawing using a learning model and image manipulation is disclosed. In one embodiment, the method includes generating a drawing from a drawn line and text by a machine learning (ML) model. The method also includes predicting a realistic prompt and a scaling amount about the drawing using a language model and estimating a depth map of the drawing using a depth model according to the scaling amount. The method also includes rendering the drawing within a realistic scene by an outpainting model using the realistic prompt and the depth map.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an illustration system that generates drawings iteratively using models and renders realistic scenes having the drawings.

FIG. 2 illustrates one embodiment of a pipeline for the illustration system that generates drawings using the models that are guided by sketches and outputs a drawing selected within realistic scenes.

FIG. 3 illustrates one embodiment of the illustration system having models that render a generative drawing within realistic scenes.

FIG. 4 illustrates an example of a user interface (UI) that can modify a generative drawing and render various realistic scenes exhibiting the generative drawing.

FIG. 5 illustrates one embodiment of a method that is associated with predicting a realistic prompt and scale about a generative drawing and rendering a realistic scene accordingly.

### DETAILED DESCRIPTION

Systems, methods, and other embodiments associated with creating a realistic scene including a generative drawing using a learning model and image manipulation are disclosed herein. In various implementations, systems generating drawings and images from text lack capabilities associated with incorporating scene information. For example, designing a vehicle includes placing the vehicle within various scenes for stakeholders (e.g., marketing) to fully visualize and understand a concept. Furthermore, manually constructing a surrounding scene having a designed drawing can be a laborious task, such as placing individual elements (e.g., trees, furniture, etc.) around a design object. Accordingly, a design cycle is left incomplete without incorporating design ideas into relevant scenes and leaves stakeholders from fully recognizing design creativity.

Therefore, in one embodiment, an illustration system generates drawings through sketching and text that improves ideation by placing a generative drawing selected within realistic scenes. In particular, the illustration system iteratively generates drawings from sketches using a machine learning (ML) model and a feedback loop until a generative drawing is selected. The illustration system can then predict a realistic prompt and a scaling amount about the drawing using a language model. Here, the realistic prompt guides generating a realistic scene exhibiting the generative drawing by describing a subject (e.g., a vehicle) for the generative drawing within a natural setting. The scaling amount (e.g., 60%) improves realism by factoring relationships between objects within the generative drawing. Furthermore, a depth model (e.g., a neural network (NN)) estimates a depth map of the generative drawing using the scaling amount for adding a three-dimensional (3D) structure within the realistic scene. In one approach, the illustration system renders the generative drawing within the realistic scene with an outpainting model using the realistic prompt and the depth map. For example, the outpainting model can accurately add balanced lighting and shadows that correspond with pixel-based depth from the depth map and a subject derived from the realistic prompt. Therefore, the illustration system improves design visualization and intent for stakeholders by rendering realistic scenes having a generative drawing produced with learning models following text and sketch inputs as guidelines.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

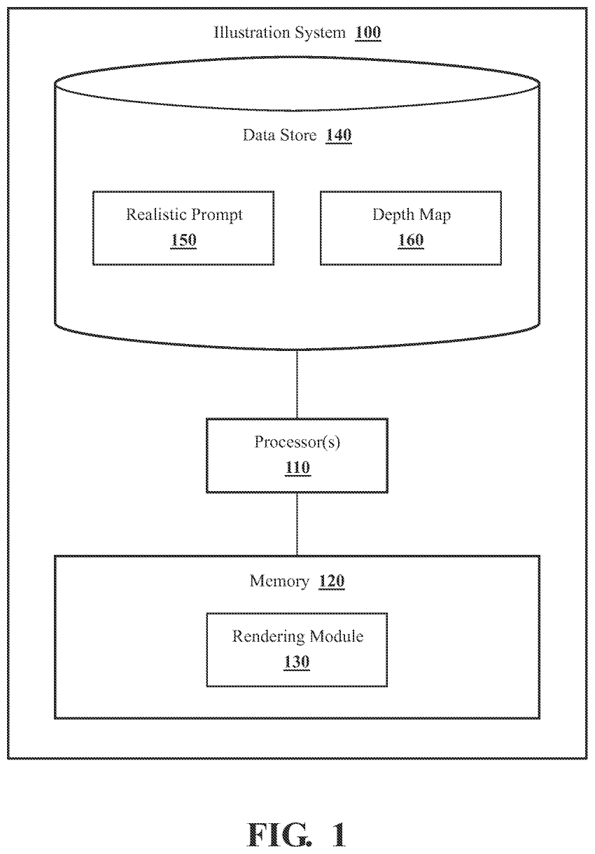

FIG. 1 illustrates one embodiment of an illustration system 100 that generates drawings iteratively using models and renders realistic scenes having the drawings. The illustration system 100 is shown as including a processor(s) 110 that the illustration system 100 may access through a data bus or another communication path. In one embodiment, the illustration system 100 includes a memory 120 that stores a rendering module 130. The memory 120 is a random-access memory (RAM), a read-only memory (ROM), a hard-disk drive, a flash memory, or other suitable memory for storing the rendering module 130. The rendering module 130 is, for example, computer-readable instructions that when executed by the processor(s) 110 cause the processor(s) 110 to perform the various functions disclosed herein.

Moreover, in one embodiment, the illustration system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the rendering module 130 in executing various functions. In one embodiment, the data store 140 further includes realistic prompt 150 and depth map 160. For example, the realistic prompt 150 describes a subject (e.g., car) associated with a drawing (e.g., race car) within a natural setting (e.g., urban). The depth map 160 may include pixel-based depth estimated by a depth model (e.g., a neural network (NN)). As such, the illustration system 100 can identify depth relationships between pixels and objects within the drawing using the depth map 160.

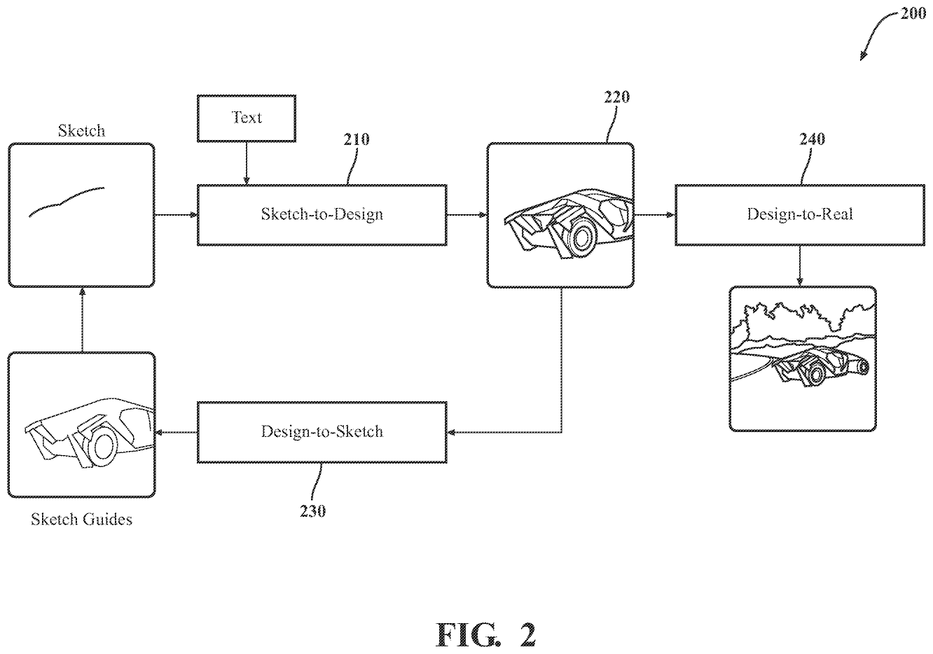

The illustration system 100 as illustrated in FIG. 2 is generally an abstracted form. The illustration system 100 and the rendering module 130, in one embodiment, also include instructions that cause the processor(s) 110 to generate a drawing from a drawn line and text by a machine learning (ML) model. Furthermore, the illustration system 100 predicts a realistic prompt and a scaling amount about the drawing using a language model and estimates the depth map 160 of the drawing using a depth model according to the scaling amount. In one approach, the rendering module 130 renders the drawing within a realistic scene through an outpainting model using the realistic prompt and the depth map 160.

Concerning FIG. 2, one embodiment of a pipeline 200 for the illustration system 100 that generates drawings using the models that are guided by sketches and output a drawing selected within realistic scenes is illustrated. Models are referenced for the pipeline 200 in FIG. 2. A model may include one or more subnetworks, networks, physical models, data-driven models, mathematical models, and so on as understood by those having ordinary skill in the art. Prior to selecting and placing a generative image within a realistic scene, in one approach, a model sketch-to-design 210 converts a drawn line and text inputted about a concept and generates design ideas. For example, a designer inputs a subject (e.g., a vehicle) and an initial concept that is abstract (e.g., sporty) as the text along with the drawn line. A large language model (LLM) (e.g., a Chat generative pre-trained transformer (GPT)) within the sketch-to-design 210 processes the subject and initial concept to generate analogical inspirations and ideas. An analogical inspiration can involve robustly and rapidly associating relevant connections between diverse domains (e.g., nature, architecture, fashion, etc.) for inputs. Here, the text can prompt the LLM to detail a design principle for a subject: “Describe the key design principles in <subject> design in a brief sentence or paragraph.” In this way, the prompt also can be context for the LLM to generate thoughtful and intriguing inspirations.

Additionally, the illustration system 100 prompts the LLM to generate inspirations from diverse domains (e.g., nature, history, architecture, fashion, etc.) through factoring the design principles. For example, the prompt is that you are a <subject> designer and the design principles in <subject> design are from <design principles> involving initial generative predictions. The LLM then searches, creates, and ideates inspirations for <subject> design that convey a sense of <concept> from a domain set, such as nature, history, architecture, fashion, etc. Furthermore, the illustration system 100 can request that the answer format from the LLM is a sentence, bullet-pointed list (e.g., five items), etc. A design concept can be enhanced through iterations by exploring domains and following recommendations from the LLM.

Following a design idea selected from those recommended by the LLM, a ML model (e.g., a neural network) within the sketch-to-design 210 receives the drawn line. For example, the drawn line is captured by a canvas on a UI. Here, in one approach, the ML model is a controlnet that receives the design idea as text and the drawn line and renders a generative image 220. In various implementations, the controlnet uses a stable diffusion model that improves semantic capture with a variational autoencoder (VAE) for compressing an image from a pixel space to a latent space having reduced dimensionality. For instance, the stable diffusion model can iteratively apply Gaussian noise to the compressed latent representation during forward diffusion. A U-Net can subsequently denoise the output from forward diffusion backwards to obtain a latent representation. The operation completes with the VAE decoding and generating an image by converting the latent representation back into the pixel space.

Additionally, the illustration system 100 continues guiding design concepts and ideas using additional strokes inputted and modifying sketches estimated with a model design-to-sketch 230. Additional strokes trigger new design generation and make the creation process iterative. The illustration system 100 also encourages focusing on sketching rather than engineering text prompts that increases creativity and reduces development time.

In various implementations, the illustration system 100 maintains an initial seed between generations for consistent and rapid image generation. Here, a seed may be additional text, words, images, etc. that is inputted to the sketch-to-design 210. In another approach, the illustration system 100 receives a remix command that changes to a different seed and the sketch-to-design 210 generates a varied image accordingly. This process can include remixing text to generate varied forms of the image from randomizing seeds associated with design parameters. Furthermore, a model design-to-sketch 230 can generate a sketch from a generative image outputted by the sketch-to-design 210 and include a feedback loop that builds and refines the generative image.

Regarding details about the design-to-sketch 230, the model segments the generative drawing to identify boundaries with a segmentation model (e.g., a NN) and extracts edges from the generative drawing using an edge model, such as a holistically-nested edge detection (HED) model. Furthermore, the design-to-sketch 230 renders an estimated sketch of the generative drawing by computing an intersection between the boundaries and the edges. Here, the intersection can remove texture and redundant patterns within a generative image for areas and objects having key silhouettes and edges. As such, the illustration system 100 generates a sketch having realistic and defined aesthetics. In this way, the design-to-sketch 230 assists a designer and stakeholders with visualizing a generative design in a high-definition and sketch-style format.

Moreover, the feedback loop through the design-to-sketch 230 renders an estimated sketch from a generative drawing so that designers can further build and enhance generative drawings through leveraging sketch-style visuals. For example, the illustration system 100 regenerates an initial generative drawing with a modified form of the estimated sketch. In this way, the estimated sketch incentivizes inspirations from previously generated drawings and reduces challenges associated with starting with a blank canvas characteristic of early designs. Therefore, the illustration system 100 implements iterative sketching for ideation through the feedback loop allowing a sketch-to-design-to-sketch form.

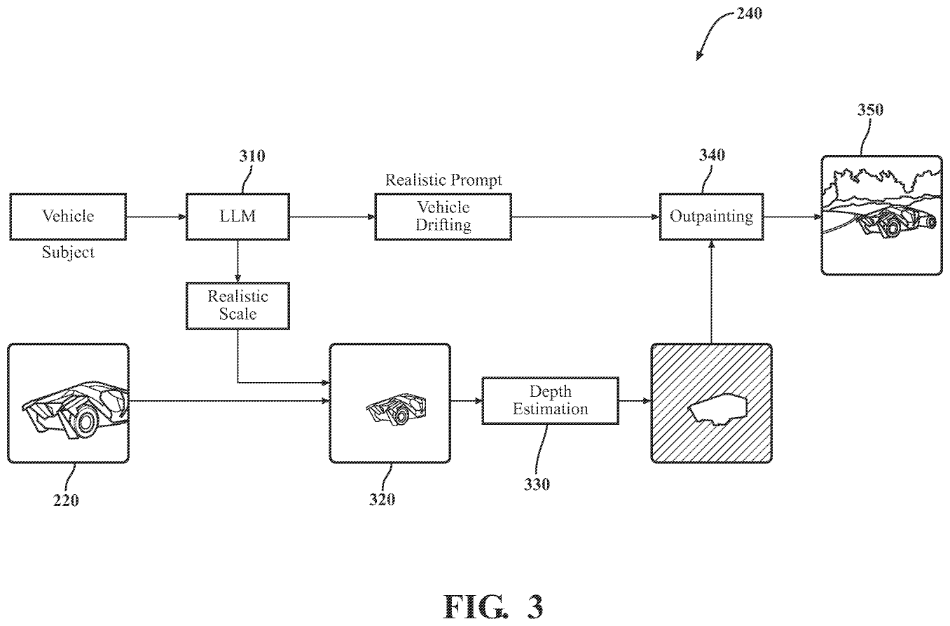

Upon selecting a generative drawing as a candidate drawing, FIG. 3 illustrates a model design-to-real 240 executing computations with the candidate drawing for visualization within a realistic scene, environment, scenario, etc. The design-to-real 240 includes a LLM 310 as a language model, language transformer, etc. that processes a prompt. In one approach, the LLM 310 receives an input that describes a subject (e.g., vehicle) of the candidate drawing. This input may be supplied manually for the output from the sketch-to-design 210, automatically supplied by the sketch-to-design 210, etc. In another approach, the LLM 310 processes subject and concept inputs about the candidate drawing for placing the subject within the realistic scene and predicting a scaling amount. In either case, the input can request and prompt the LLM 310 to describe the subject in a realistic scenario and scene. For instance, the input is “Describe <subject> in a natural setting in a brief sentence.” The output of the LLM 310 is a realistic prompt describing a synthetic background, elements, etc. for a scene and scenario that is befitting of the subject and the candidate drawing. For instance, a realistic prompt is “a sportscar driving on a curvy road in the mountains.”

In various implementations, the prompt triggers the LLM 310 to reason and estimate a realistic scale (e.g., 40%) that is appropriate for the subject: “How much of the candidate drawing would <subject> cover in a scene? Give a percentage.” The design-to-real 240 rescales the candidate drawing to rescaled representation 320. Rescaling improves realism through accurately relating geometries and relationships between objects within a scene. Otherwise, the candidate image can be excessively focused and overlarged within the scene. Furthermore, the depth estimation 330 estimates the depth map 160 using a model, such as a NN, MiDaS, etc., trained with annotated data. The depth estimation 330 can approximate a three-dimensional (3D) structure of the candidate drawing using the depth map 160 and identify depth relationships between pixels and objects among the candidate drawing and the realistic scene. In this way, the depth estimation 330 prevents the candidate drawing from having a “floating” and other fake qualities within the realistic scene and supplies the outpainting 340 with object priors. In this example, an object prior is a probabilistic distribution that is imputed or an initial belief about data before the outpainting 340 factors inputs.

Concerning details about the outpainting 340, the design-to-real 240 feeds the outpainting 340 with the depth map 160 and the realistic prompt describing the subject within the realistic scene. Here, the outpainting may be a data-driven model such as stable diffusion, Adobe FireFly™, etc. In one approach, the outpainting 340 leverages the 3D structure approximated from the depth map 160 to plant the candidate drawing into a realistic scene with appropriate lighting, shading, and shadows. The realistic scene having the candidate drawing 350 is synthetic while still exhibiting accurate scale, spatial relations, and lighting.

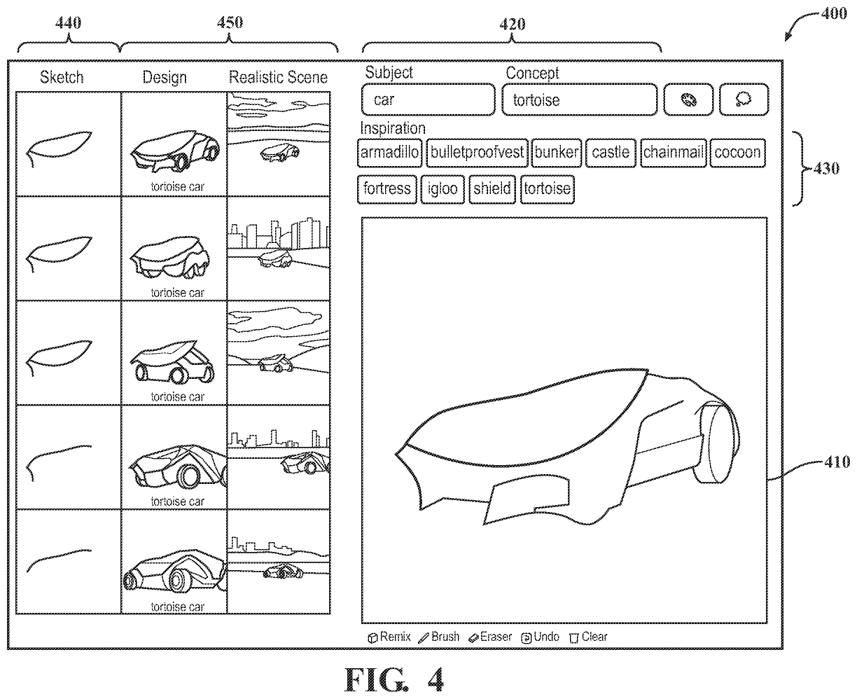

Turning now to FIG. 4, an example of a user interface (UI) 400 that can modify a generative drawing and render various realistic scenes exhibiting the generative drawing is illustrated. For enhancing user experience, the illustration system 100 can underlay an estimated sketch outputted from design-to-sketch 230 within a canvas 410 on the UI 400. As previously explained, the estimated sketch can be accurately rendered from a generative drawing outputted by the sketch-to-design 210 using a drawn line, subject and concept inputs 420, and inspirations 430. The canvas 410 allows a designer to modify an estimated sketch as displayed within the panel 440. The sketch-to-design 210 can receive the estimated sketch having modifications for forming a feedback loop until selection of a candidate drawing.

Moreover, the design-to-real 240 executes computations with the candidate drawing for visualization within a realistic scene and output the various designs 450 including within the realistic scene. The pipeline for the design-to-real 240 can include LLM prompting, rescaling, depth estimation, and outpainting for outputting the various designs 450. Accordingly, the illustration system 100 achieves rapid ideation and full development cycles by generating a drawing guided by text and a drawn line and placing a candidate drawing within a realistic scene using models.

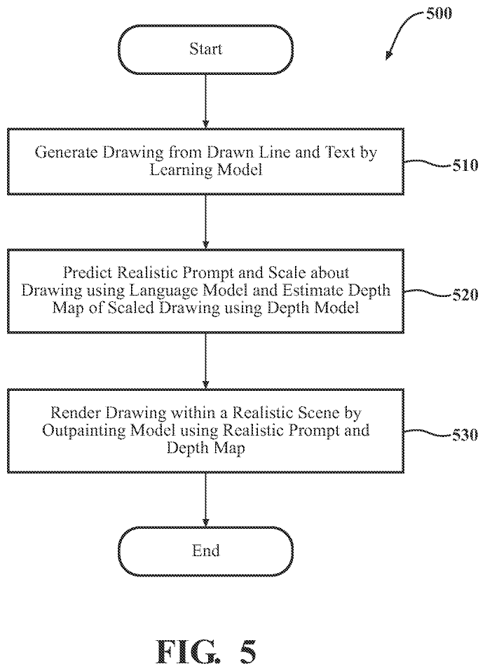

Additional aspects of the illustration system 100 will be discussed in relation to FIG. 5. FIG. 5 illustrates a flowchart of a method 500 that is associated with creating a realistic scene having a generative drawing using a learning model and image manipulation. Method 500 will be discussed from the perspective of the illustration system 100 of FIG. 1. While method 500 is discussed in combination with the illustration system 100, it should be appreciated that the method 500 is not limited to being implemented within the illustration system 100 but is instead one example of a system that may implement the method 500. In particular, the method 500 decreases times for designing objects, prototypes, and products through drawings and text and places a drawing candidate in a realistic scene, thereby providing an end-to-end design cycle.

At 510, the illustration system 100 generates a drawing from a drawn line and text by a learning model. In one approach, a sketch-to-design model generates drawing ideas by converting a drawn line and text inputted about a concept. Here, a designer can input a subject and an initial concept about a design that is abstract as the text and further guide the design with the drawn line, thereby having a multi-model approach. A tranformer model (e.g., a large language model (LLM), chat generative pre-trained transformer (GPT), etc.) within the sketch-to-design processes the subject and initial concept and outputs analogical inspirations. For instance, analogical inspirations robustly and rapidly identify relevant relationships and connections between diverse, disparate domains (e.g., nature, architecture, fashion, etc.) for inputs. For example, attention mechanisms within a transformer identify the connections by relating different positions of a single sequence to compute a representation associated with the same sequence. Furthermore, the text can prompt the transformer model to detail a design principle for an inputted subject. In this way, the transformer model derives context about the design from the prompt and generates compelling and intriguing inspirations accordingly.

Moreover, the illustration system 100 prompts the transformer model to generate inspirations from the diverse domains through factoring the design principles. For example, the prompt is that you are a <subject> designer and the design principles in <subject> design is from <design principles>. The transformer model ideates inspirations for <subject> design that are correlated with a <concept> from a domain set. In this way, the transformer model rapidly improves a design concept through iteratively exploring domains and following recommendations.

Upon selecting a design idea that is recommended from the transformer model, a ML model of the sketch-to-design processes a drawn line. In one approach, the ML model is a controlnet that receives the design idea as text and the drawn line and renders a generative image. The illustration system 100 continues guiding concepts and ideas using additional strokes inputted and modifying sketches estimated with a model design-to-sketch. Here, the additional strokes trigger new and creative design generation and reduce iterations by removing descriptive limitations associated with textual inputs. The design-to-sketch segments the generative drawing to identify boundaries with a segmentation model (e.g., a NN) and extracts edges from the generative drawing using an edge model. As previously explained, the design-to-sketch renders an estimated sketch of the generative drawing by computing an intersection between the boundaries and the edges, thereby removing unnecessary texture and redundant patterns within a generative image that affect sketch resolution. Correspondingly, the sketch has realistic and defined aesthetics for further enhancements through modification.

Moreover, a feedback loop through the design-to-sketch renders an estimated sketch from a generative drawing for further building and enhancing generative drawings through the sketch-style visuals. As previously explained, the estimated sketch also incentivizes inspirations from previously generated drawings by mitigating difficulties associated with a blank canvas. Therefore, the feedback loop forms a sketch-to-design-to-sketch paradigm that improves generative design using text, a drawn line, and modified sketches of initial generations.

At 520, the illustration system 100 predicts a realistic prompt and a scale about a drawing using a language model and estimates a depth map of a scaled image using a depth model. Here, a model design-to-real can execute computations with a candidate drawing generated by the sketch-to-design-to-sketch paradigm for visualization within a realistic scene, scenario, etc. As previously explained, the design-to-real includes a language model (e.g., a language transformer, LLM, etc.) that processes a prompt, such as a subject (e.g., vehicle) of the candidate drawing associated with the output from the sketch-to-design. The language model may also process subject and concept inputs about the candidate drawing for placing the subject within the realistic scene and predicting a scaling amount. Under either alternative, the input can request and prompt the language model to describe the subject in a realistic scenario and scene. Correspondingly, the output of the language model describes a synthetic background for a scene related with the subject and the candidate drawing.

In one approach, the prompt has the language model reason and estimate a realistic scale related to the subject: “Estimate a size of the candidate drawing <subject> in relation to a scene and give a percentage.” The design-to-real rescales the candidate design and generates a rescaled representation that improves realism between objects, the candidate drawing, and the <subject> within a scene. Regarding depth, a model (e.g., a NN, MiDaS, etc.) for depth estimation predicts a depth map using the rescaled representation. Here, the design-to-real estimating the depth map can involve approximating a 3D structure of the candidate drawing and supplying subsequent tasks with object priors. Furthermore, the estimation can involve locating depth relationships between pixels, objects, and scene elements among the candidate drawing and the realistic scene, thereby improving realism.

At 530, the rendering module 130 renders a drawing within a realistic scene by an outpainting model processing the realistic prompt and the depth map. The design-to-real feeds the outpainting model with the depth map and the realistic prompt describing the subject within the realistic scene. Here, the outpainting may be a data-driven model such as stable diffusion. The outpainting model can leverage the 3D structure approximated from the depth map and situate the candidate drawing into a realistic scene with appropriate lighting, shading, and shadows. Accordingly, the illustration system 100 generates the candidate drawing within a realistic scene that exhibits accurate scale, depth, and lighting, thereby completing a design cycle and reducing design times.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An illustration system comprising:
a memory storing instructions that, when executed by a processor, cause the processor to:
generate a drawing from a drawn line and text by a machine learning (ML) model;
predict a realistic prompt and a scaling amount about the drawing using a language model and estimate a depth map of the drawing using a depth model according to the scaling amount; and
render the drawing within a realistic scene by an outpainting model using the realistic prompt and the depth map.

2. The illustration system of claim 1 further including instructions to:
approximate a three-dimensional (3D) structure of the drawing using the depth map, and the depth model is a neural network (NN) that identifies depth relationships between pixels and objects within the drawing and feeds the outpainting model priors of the objects.

3. The illustration system of claim 2, wherein the instructions to render the drawing further include instructions to:
add lighting and shadows with the outpainting model according to the depth map and a subject associated with the realistic prompt, wherein the outpainting model is a stable diffusion model.

4. The illustration system of claim 1, wherein the instructions to predict the realistic prompt further include instructions to:
process subject and concept inputs about the drawing for placing the subject within the realistic scene and predicting the scaling amount.

5. The illustration system of claim 4, further including instructions to:
segment the drawing to identify boundaries with a segmentation model and extracting edges from the drawing using an edge model;
render an estimated sketch of the drawing by computing an intersection between the boundaries and the edges; and
regenerate the drawing with a modified form of the estimated sketch.

6. The illustration system of claim 1, wherein the instructions to generate the drawing from the drawn line further include instructions to:
process the text by a large language model (LLM) of the ML model to output ideas, wherein the text includes a subject and a concept associated with the ideas; and
form the drawing by a neural network (NN) of the ML model according to one of the ideas selected and the drawn line.

7. The illustration system of claim 1, wherein the realistic prompt describes a subject associated with the drawing within a natural setting and the scaling amount factors relationships between objects within the drawing.

8. The illustration system of claim 1, wherein the language model is one of a large language model (LLM) and a language transformer model and the realistic scene is synthetic.

9. A non-transitory computer-readable medium comprising:
instructions that when executed by a processor cause the processor to:
generate a drawing from a drawn line and text by a machine learning (ML) model;
predict a realistic prompt and a scaling amount about the drawing using a language model and estimate a depth map of the drawing using a depth model according to the scaling amount; and
render the drawing within a realistic scene by an outpainting model using the realistic prompt and the depth map.

10. The non-transitory computer-readable medium of claim 9, further including instructions to:
approximate a three-dimensional (3D) structure of the drawing using the depth map, and the depth model is a neural network that identifies depth relationships between pixels and objects within the drawing and feeds the outpainting model priors of the objects.

11. The non-transitory computer-readable medium of claim 10, wherein the instructions to render the drawing further include instructions to:
add lighting and shadows with the outpainting model according to the depth map and a subject associated with the realistic prompt, wherein the outpainting model is a stable diffusion model.

12. The non-transitory computer-readable medium of claim 9, wherein the instructions to predict the realistic prompt further include instructions to:
process subject and concept inputs about the drawing for placing the subject within the realistic scene and predicting the scaling amount.

13. A method comprising:
generating a drawing from a drawn line and text by a machine learning (ML) model;
predicting a realistic prompt and a scaling amount about the drawing using a language model and estimating a depth map of the drawing using a depth model according to the scaling amount; and
rendering the drawing within a realistic scene by an outpainting model using the realistic prompt and the depth map.

14. The method of claim 13 further comprising:
approximating a three-dimensional (3D) structure of the drawing using the depth map, and the depth model is a neural network that identifies depth relationships between pixels and objects within the drawing and feeds the outpainting model priors of the objects.

15. The method of claim 14, wherein rendering the drawing further includes:
adding lighting and shadows with the outpainting model according to the depth map and a subject associated with the realistic prompt, wherein the outpainting model is a stable diffusion model.

16. The method of claim 13, wherein predicting the realistic prompt further includes:
processing subject and concept inputs about the drawing for placing the subject within the realistic scene and predicting the scaling amount.

17. The method of claim 16 further comprising:
segmenting the drawing to identify boundaries with a segmentation model and extracting edges from the drawing using an edge model;
rendering an estimated sketch of the drawing by computing an intersection between the boundaries and the edges; and
regenerating the drawing with a modified form of the estimated sketch.

18. The method of claim 13, wherein generating the drawing from the drawn line further includes:
processing the text by a large language model (LLM) of the ML model to output ideas, wherein the text includes a subject and a concept associated with the ideas; and
forming the drawing by a neural network (NN) of the ML model according to one of the ideas selected and the drawn line.

19. The method of claim 13, wherein the realistic prompt describes a subject associated with the drawing within a natural setting and the scaling amount factors relationships between objects within the drawing.

20. The method of claim 13, wherein the language model is one of a large language model (LLM) and a language transformer model and the realistic scene is synthetic.
